(19) United States
(12) Patent Application Publication
(10) Pub. No.: US 2020/0209270 A1
(43) Pub. Date: Jul. 2, 2020

(54) SAMPLE CONTAINER CARRIER, LABORATORY SAMPLE DISTRIBUTION SYSTEM AND LABORATORY AUTOMATION SYSTEM

(71) Applicant: Roche Diagnostics Operations, Inc., Indianapolis, IN (US)

(72) Inventors: Marcel Kaeppeli, Merenschwand (CH); Ken Mueller, Zug (CH); Rudolf Durco, Kornwestheim (DE)

(73) Assignee: Roche Diagnostics Operations, Inc., Indianapolis, IN (US)

(21) Appl. No.: 16/804,509

(22) Filed: Feb. 28, 2020

Related U.S. Application Data
(63) Continuation of application No. PCT/EP2018/074123, filed on Sep. 7, 2018.

(30) Foreign Application Priority Data
Sep. 13, 2017 (EP) 17190907.0

(51) Int. Cl. G01N 35/04

(52) U.S. Cl. CPC G01N 35/04; B01L 9/06

(57) ABSTRACT

A sample container carrier, a laboratory sample distribution system comprising such a sample container carrier and a laboratory automation system comprising such a laboratory sample distribution system are presented.

### CROSS-REFERENCE TO RELATED APPLICATIONS

This application is a continuation of PCT/EP2018/074123, filed Sep. 7, 2018, which is based on and claims priority to EP 17190907.0, filed Sep. 13, 2017, which is hereby incorporated by reference.

### BACKGROUND

The present disclosure generally relates to a sample container carrier, a laboratory sample distribution system comprising such a sample container carrier and a laboratory automation system comprising such a laboratory sample distribution system.

Known laboratory sample distribution systems are typically used in laboratory automation systems in order to distribute laboratory samples contained in laboratory sample containers between different laboratory stations by means of sample container carriers. The sample container carrier comprises spring arms for holding the laboratory sample container.

However, there is a need for a sample container carrier having improved properties.

### SUMMARY

According to the present disclosure, a sample container carrier for holding a laboratory sample container and for transporting the held laboratory sample container in a laboratory sample distribution system is presented. The sample container carrier can comprise a first holding element and a second holding element. The first holding element and the second holding element can be displaceable towards and/or away from each other within a holding region for holding the laboratory sample container. At least one of the first and second holding elements can be rotationally displaceable. The sample container carrier can also comprise a coupler. The coupler can be connected to the first holding element and to the second holding element within a coupling region such that the coupler can couple displacements of the first holding element and the second holding element. The coupler can be rotationally moveable such that the coupler can couple by its rotational movement the displacements of the first holding element and the second holding element. The sample container carrier can also comprise a prevention element. The prevention element can be spatially arranged between the holding region and the coupling region and can be configured to prevent the laboratory sample container and/or a laboratory sample from getting into the coupling region. The coupling region and the holding region can be arranged along a central axis (CA) of the sample container carrier. The coupler can be moveably mounted to the prevention element. The sample container carrier can also comprise a coupler-holder. The coupler-holder can extend from the prevention element away into the coupling region. The prevention element and the coupler-holder can be embodied as one piece. The coupler can be pivot-mounted to the coupler-holder such that the central axis (CA) can be a rotational axis of the coupler.

Accordingly, it is a feature of the embodiments of the present disclosure to provide a sample container carrier having improved properties. Other features of the embodiments of the present disclosure will be apparent in light of the description of the disclosure embodied herein.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 illustrates a perspective view of a sample container carrier according to an embodiment of the present disclosure.

FIG. 2 illustrates another perspective view of the sample container carrier of FIG. 1 according to an embodiment of the present disclosure.

FIG. 3 illustrates a cross section view of the sample container carrier of FIG. 1 according to an embodiment of the present disclosure.

FIG. 4 illustrates a perspective view of holding elements, a coupler and a prevention element of the sample container carrier of FIG. 1 according to an embodiment of the present disclosure.

FIG. 5 illustrates another perspective view of the holding elements, the coupler and the prevention element of FIG. 1 according to an embodiment of the present disclosure.

FIG. 6 illustrates a perspective view of one of the holding elements of the sample container carrier of FIG. 1 according to an embodiment of the present disclosure.

FIG. 7 illustrates a perspective view of a laboratory automation system comprising the sample container carrier of FIG. 1 holding a laboratory sample container according to an embodiment of the present disclosure.

FIG. 8 illustrates a schematic cross section view of the sample container carrier of FIG. 1 holding the laboratory sample container according to an embodiment of the present disclosure.

FIG. 9 illustrates a perspective view of a sample container carrier according to an embodiment of the present disclosure.

FIG. 10 illustrates another perspective view of the sample container carrier of FIG. 9 according to an embodiment of the present disclosure.

FIG. 11 illustrates a cross section view of the sample container carrier of FIG. 9 according to an embodiment of the present disclosure.

FIG. 12 illustrates a perspective view of holding elements, a coupler and a prevention element of the sample container carrier of FIG. 9 according to an embodiment of the present disclosure.

FIG. 13 illustrates another perspective view of the holding elements, the coupler and the prevention element of FIG. 9 according to an embodiment of the present disclosure.

FIG. 14 illustrates a perspective view of one of the holding elements of the sample container carrier of FIG. 9 according to an embodiment of the present disclosure.

FIG. 15 illustrates a lower housing part of the sample container carrier of FIG. 9 according to an embodiment of the present disclosure.

FIG. 16 illustrates an upper housing part of the sample container carrier of FIG. 9 according to an embodiment of the present disclosure.

### DETAILED DESCRIPTION

In the following detailed description of the embodiments, reference is made to the accompanying drawings that form a part hereof, and in which are shown by way of illustration, and not by way of limitation, specific embodiments in which the disclosure may be practiced. It is to be understood that other embodiments may be utilized and that logical, mechanical and electrical changes may be made without departing from the spirit and scope of the present disclosure.

A sample container carrier for holding a laboratory sample container and for transporting the held laboratory sample container in a laboratory sample distribution system is presented. The sample container carrier can comprise a first holding element and a second holding element. The first holding element and the second holding element can be displaceable such as, for example, rotationally displaceable, towards and/or away from each other within a holding region for holding the laboratory sample container. Furthermore, the sample container carrier can comprise a coupler. The coupler can be connected such as, for example, directly and/or mechanically connected, to the first holding element and to the second holding element within a coupling region such that the coupler can couple displacements such as, for example, rotational displacements, of the first holding element and the second holding element such as, for example, with each other. Moreover, the sample container carrier can comprise a prevention element. The prevention element can be spatially arranged between the holding region and the coupling region and can be configured to prevent the laboratory sample container and/or a laboratory sample from getting into the coupling region. The coupling region and the holding region can be arranged along a central axis of the sample container carrier. The coupler can be rotationally moveable such that the coupler can couple by its rotational movement the displacements of the first holding element and the second holding element such as, for example, with each other. The coupler can be moveably mounted to the prevention element. The sample container carrier can comprise a coupler-holder. The coupler-holder can extend from the prevention element away into the coupling region. The prevention element and the coupler-holder can be embodied as one piece. The coupler can be pivot-mounted to the coupler-holder such that the central axis can be a rotational axis of the coupler. At least one, in particular all, of the holding elements can be, in particular only, rotationally displaceable.

The laboratory sample container may be designed as a tube made of glass or transparent plastic and may have an opening at an upper end. The laboratory sample container may be used to contain, store and transport a laboratory sample such as a blood sample, a urine sample or a chemical sample.

The sample container carrier may comprise only or exactly the two holding elements, namely the first holding element and the second holding element. Alternatively, the sample container carrier may comprise a third holding element, or, additionally a fourth holding element, or even more holding elements. All of the holding element/s may be displaceable towards and/or away from each other within the holding region for holding the laboratory sample container. The coupler may be connected to all of the holding elements within the coupling region such that the coupler may couple displacements of all of the holding elements. At least one, in particular all, of the holding elements may not be or does/do not have to be translationally displaceable. In one embodiment, at least one, in particular all, of the holding elements, may be substantially horizontally displaceable such as, for example, substantially orthogonal to the central axis of the sample container carrier. In other words, at least one, in particular all, of the holding elements may not be or does/do not have to be vertically displaceable such as, for example, along the central axis.

The first holding element and/or the second holding element may be configured to be in direct contact with the laboratory sample container for holding the laboratory sample container. The contact between the holding elements and the laboratory sample container may take place within the holding region. The holding region may be defined and/or limited by the holding elements. Additionally or, alternatively, the holding region may be defined by the prevention element and/or a base body, if present, of the sample container carrier. The holding region may be open at one side such as, for example, at a top or face side such as, for example, for enabling an insertion of the laboratory sample container into the sample container carrier. The held laboratory sample container may be at least partially positioned between the first holding element and the second holding element. In one embodiment, the first holding element and the second holding element may be arranged in a symmetric manner around a center and/or the central axis of the sample container carrier such that a point or line of contact, i.e. holding, of each of the first holding element and the second holding element with the laboratory sample container is equidistant from the center and/or from the central axis of the sample container carrier. The center may be located on the central axis. The center may be a center of gravity of the sample container carrier. The central axis may be a symmetry axis of the sample container carrier such as, for example, a longitudinal and/or a vertical axis. In other words, the held laboratory sample container may be centralized by the first holding element and the second holding element into the center of the sample container carrier. The held laboratory sample container may comprise a circumference, wherein the first holding element and/or the second holding element hold the laboratory sample container at its circumference within the holding region. The held laboratory sample container may be held by the first holding element and/or the second holding element such that the opening of the laboratory sample container, if present, may be facing away from the sample container carrier such as, for example, the prevention element. Furthermore, the held laboratory sample container such as, for example, an end face or a bottom of the laboratory sample container, may be supported by the prevention element.

The coupler may be a mechanical coupler. In one embodiment, the coupler may be a lever, a slide, a belt, a rubber band or a gear-wheel. The coupler may be configured to perform a movement, when the first holding element and/or the second holding element may be displaced. The coupler may be configured to transfer a displacement of the first holding element into a displacement of the second holding element. The coupler may be configured to transfer a displacement of the second holding element into a displacement of the first holding element. The coupling region may be defined and/or limited by the prevention element and/or the base body, if present. In one embodiment, the coupler may be, in particular completely, arranged spatially arranged within the coupling region. The coupler may be only rotationally moveable. The coupler may be rotationally moveable around the center and/or the central axis of the sample container carrier. The coupler may perform a rotational movement when the first holding element and/or the second holding element are/is displaced. The coupler may not perform a translational movement. The coupler may be moveably mounted to the base body, if present.

The sample container carrier may enable a synchronization of the displacements of the first holding element and the second holding element. This may enable holding the laboratory sample container in a defined holding position such as, for example, independent from a type and/or a size of the laboratory sample container. Furthermore, this may enable each of the first holding element and the second holding element to apply a similar or identical holding force value to the laboratory sample container. Thereby, balanced forces may be provide.

The prevention element may enable to avoid a malfunction of the sample container carrier such as, for example, its coupler and its coupling mechanism, respectively, which may be caused by the laboratory sample container and/or the laboratory sample. Additionally or, alternatively, the prevention element may enable to avoid a contamination or a pollution of the coupling region such as, for example, which may be caused by the laboratory sample. In other words, the prevention element may enable to keep the sample container carrier within its coupling region clean or at least to enable a relatively easy cleaning of the sample container carrier. The prevention element may enable a relatively high reliability of the sample container carrier.

In one embodiment, the prevention element may be a plate, a wall or a fence. The prevention element may be configured to prevent liquid and/or dust from getting into the coupling region. In one embodiment, the prevention element alone or the prevention element in combination with an additional sealing element may seal the coupling region in a waterproof manner. The prevention element may separate and/or divide the holding region from the coupling region. The prevention element may be an intermediate level or a middle floor of the sample container carrier. In one embodiment, the prevention element may be arranged such as, for example, spatially arranged, along a straight line between the holding region and the coupling region.

According to an embodiment, the sample container carrier can comprise a gear tooth system. The coupler can be connected to the first holding element and/or to the second holding element by the gear tooth system. The gear tooth system may be arranged within the coupling region. The gear tooth system may comprise a gear-rack, a gear-wheel or a segment of a gear-wheel.

According to an embodiment, the sample container carrier can comprise a stop element. The stop element can be configured to cooperate with the first holding element and/or the second holding element and/or the coupler such that the displacements of the first holding element and the second holding element are limited. In one embodiment, the displacements of the first holding element and the second holding element towards each other may be limited by the stop element. The stop element may define a default or relaxed position of the first holding element and/or the second holding element. The default position may be a position of the first holding

According to an embodiment, the first holding element and/or the second holding element can be displaceable mounted to the prevention element by a pivot joint. Additionally, the prevention element may be configured to guide the displacement/s of the first holding element and/or the second holding element. Additionally or, alternatively, the first holding element and/or the second holding element may be displaceable mounted to the base body.

According to an embodiment, the first holding element and/or the second holding element can extend from the prevention element away into the holding region by a maximum of 35 millimeter (mm). In another embodiment, the first holding element and/or the second holding element can extend from the prevention element away into the holding region by a maximum of 30 mm. In yet another embodiment, the first holding element and/or the second holding element can extend from the prevention element away into the holding region by a maximum of 25 mm. In still another embodiment, the first holding element and/or the second holding element can extend from the prevention element away into the holding region by a maximum of 15 mm. In still yet another embodiment, the first holding element and/or the second holding element can extend from the prevention element away into the holding region by a maximum of 10 mm. In other words, the first holding element and/or the second holding element may be configured to hold the laboratory sample container at a 35 mm, 30 mm, 25 mm, 15 mm, or 10 mm, long end portion of the laboratory sample container. Such a relatively short holding element/s may not cover a barcode arranged at the held laboratory sample container. Thereby, the barcode may be readable from the outside.

According to an embodiment, the first holding element and/or the second holding element can comprise a number of jaws (e.g., 1 to 10) within the holding region for holding the laboratory sample container. In one embodiment, each holding element may comprise only one jaw. The jaws may be configured to be in direct contact with the held laboratory sample container. Each jaw may comprise or form a circular segment or section. The number of jaws and their longitudinal axes, respectively, may be oriented substantially parallel to the center and/or the central axis. The number of jaws may comprise a number of first jaws and a number of second jaws, wherein the first holding element and the number of first jaws may be formed in one-piece and/or the second holding element and the number of second jaws may be formed in one-piece. The jaws may be distributed around the central axis in an equidistant and/or equiangular manner. At least one of the number of jaws may comprise a corrugation for holding the laboratory sample container. This may enable a relatively high friction and/or grip between the corrugated jaw and the laboratory sample container. The corrugation may be a ribbing. In one embodiment, the corrugation may be configured not to destroy and/or to affect the laboratory sample container. The number of jaws may not have to be arranged within the coupling region.

According to an embodiment, the first holding element and/or the second holding element can comprise a lever arm, wherein the lever arm can comprise a curved shape and wherein the jaw can be arranged at such as, for example, an end portion of, the lever arm such that the lever arm is not in contact, in particular in direct contact, with the laboratory sample container, when the laboratory sample container can be inserted into, held by and/or removed from the sample container carrier. This can enable a desired friction such as, for example, a relatively low friction, between at least one of the holding elements and the laboratory sample container such as, for example, during the insertion or a removal of the laboratory sample container such that the laboratory sample container may only relatively little or not be rotated during the insertion or the removal. The curved shape may be in form of a segment of a circle. The lever arm may be denoted as a flap.

According to an embodiment, the number of jaws can comprise a flexible and/or soft material for holding the laboratory sample container. This can enable a relatively reliable contact and/or a desired friction between the number of jaws and the laboratory sample container. In one embodiment, the first holding element and/or the second holding element may be a multi-component injection molding part, wherein the number of jaws can be made of a softer material such as, for example, a rubber-based-material.

According to an embodiment, the first holding element and/or the second holding element can comprise an insertion support. The insertion support is configured to cooperate together with the laboratory sample container to be held such that the holding element comprising the insertion support can be displaced when the laboratory sample container is inserted into the sample container carrier. This can enable a relatively simple insertion of the laboratory sample container to be held into the sample container carrier. The insertion support may be an inclined plane, inclined surface or inclined edge. At least one respective jaw of the number of jaws, if present, may comprise the insertion support.

According to an embodiment, the sample container carrier can comprise a retaining element applying a force to the first holding element and/or to the second holding element and/or to the coupler such that the first holding element and the second holding element can be force-loaded towards each other for holding the laboratory sample container. This can enable a relatively reliable holding of the laboratory sample container. Additionally or, alternatively, the retaining element may apply a force such that the first holding element and the second holding element may be displaced towards each other such as, for example, into the default position, if present, when the laboratory sample container may be removed from the sample container carrier. The retaining element may comprise or be an elastic element. The retaining element may comprise or be a spring, a rubber element, a rubber band, at least one magnet, a cable pull system, a pneumatic system or a hydraulic system.

According to an embodiment, the sample container carrier can comprise a magnetically active element, wherein the magnetically active element can be configured to interact with a magnetic field generated by a drive element such that a driving force such as, for example, a magnetic driving force, can be applied to the sample container carrier. The magnetically active element may be a permanent magnet or an electro-magnet. The magnetically active element may comprise a magnetically soft material.

A laboratory sample distribution system is presented. The laboratory sample distribution system can comprise a number of sample container carriers (e.g., 1 to 1000) as described above, a transport plane, a number of drive elements (e.g., 1 to 10000) and a control device. The transport plane can be configured to support the number of sample container carriers. The number of drive elements can be configured to move the number of sample container carriers on the transport plane. The control device can be configured to control the number of drive elements such that the number of sample container carriers can move on the transport plane along corresponding transport paths. The advantages of the sample container carrier as discussed above can be made applicable for the laboratory sample distribution system.

The transport plane may also be denoted as transport surface. The transport plane may support the sample container carriers, what may also be denoted as carrying the sample container carriers. The sample container carriers may be translationally moved on the transport plane. The sample container carriers may be configured to move in two dimensions on the transport plane. The number of sample container carriers may slide over the transport plane. The control device may be an integrated circuit, a tablet computer, a smartphone, a computer or a processing control system. Each of the sample container carriers may move on the transport plane along an individual transport path.

According to an embodiment, the number of drive elements can comprise a number of electro-magnetic actuators (e.g., 1 to 10000), wherein the number of electro-magnetic actuators can be stationary arranged below the transport plane and can be configured to generate a magnetic field to move the number of sample container carriers on the transport plane. Each of the number of sample container carriers can comprise a magnetically active element, wherein the magnetically active element can be configured to interact with the magnetic field generated by the number of electro-magnetic actuators such that a driving force such as, for example, a magnetic driving force, can be applied to the sample container carrier. The control device can be configured to control the number of electro-magnetic actuators such that the number of sample container carriers can move on the transport plane along corresponding transport paths. In one embodiment, the electro-magnetic actuators may be solenoids surrounding ferromagnetic cores. Furthermore, the electro-magnetic actuators may be driven or energized individually in order to generate or to provide the magnetic field. The electro-magnetic actuators may be arranged in two dimensions such as, for example, in a grid or matrix having rows and columns, along which the electro-magnetic actuators can be arranged. The electro-magnetic actuators may be arranged in a plane substantially parallel to the transport plane.

A laboratory automation system is also present. The laboratory automation system can comprise a number of laboratory stations (e.g., 1 to 50) and a laboratory sample distribution system as described above. The laboratory sample distribution system can be configured to distribute the number of sample container carriers and/or laboratory sample containers between the laboratory stations. The advantages of the laboratory sample distribution system, as discussed above, can be made applicable for the laboratory automation system.

The laboratory stations may be arranged adjacent or directly next to the laboratory sample distribution system such as, for example, to the transport plane of the laboratory sample distribution system. The number of laboratory stations may comprise pre-analytical, analytical and/or post-analytical laboratory stations. Pre-analytical laboratory stations may be configured to perform any kind of pre-processing of samples, sample containers and/or sample container carriers. Analytical laboratory stations may be configured to use a sample or part of the sample and a reagent to generate a measuring signal, the measuring signal indicating if and in which concentration, if any, an analyte exists. Post-analytical laboratory stations may be configured to perform any kind of post-processing of samples, sample containers and/or sample container carriers. The pre-analytical, analytical and/or post-analytical laboratory stations may comprise at least one of a decapping station, a recapping station, an aliquot station, a centrifugation station, an archiving station, a pipetting station, a sorting station, a tube type identification station, a sample quality determining station, an add-on buffer station, a liquid level detection station, a sealing/desealing station, a pushing station, a belt station, a conveying system station and/or a gripper station for moving the sample container to or from the sample container carrier.

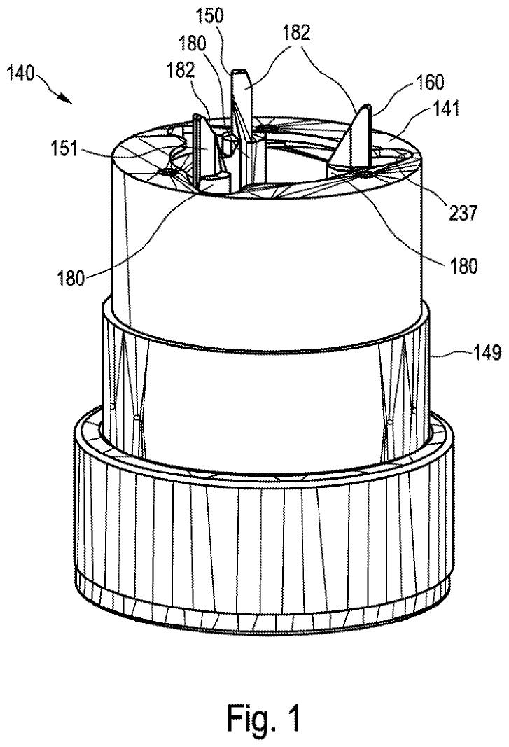

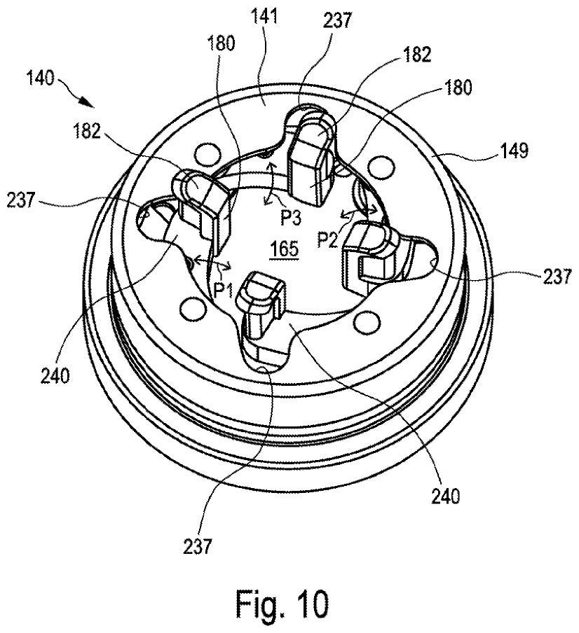

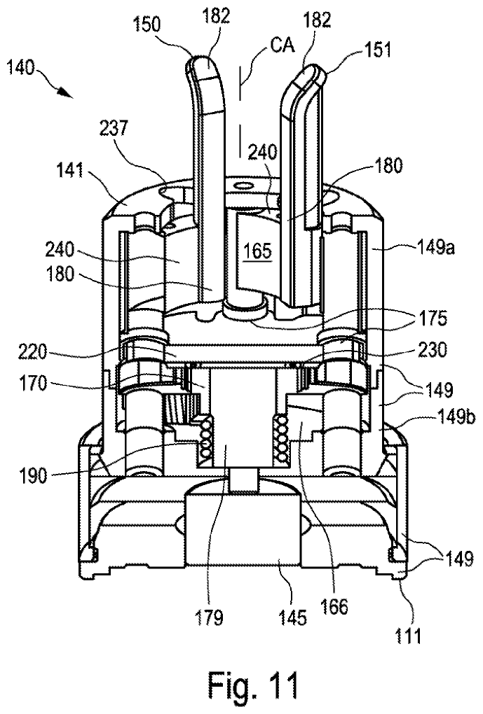

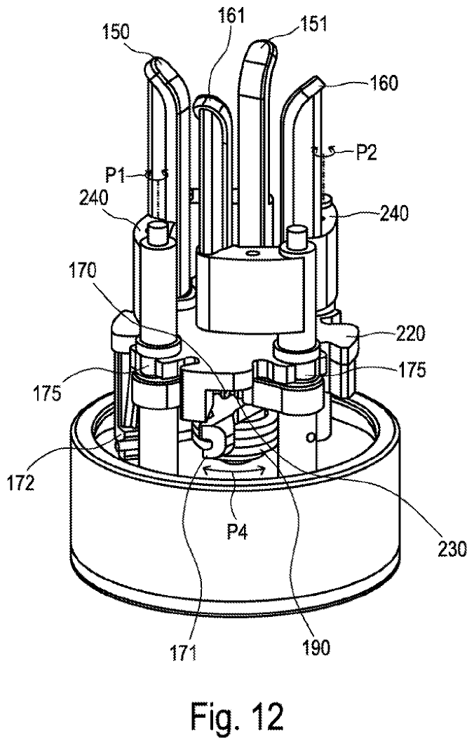

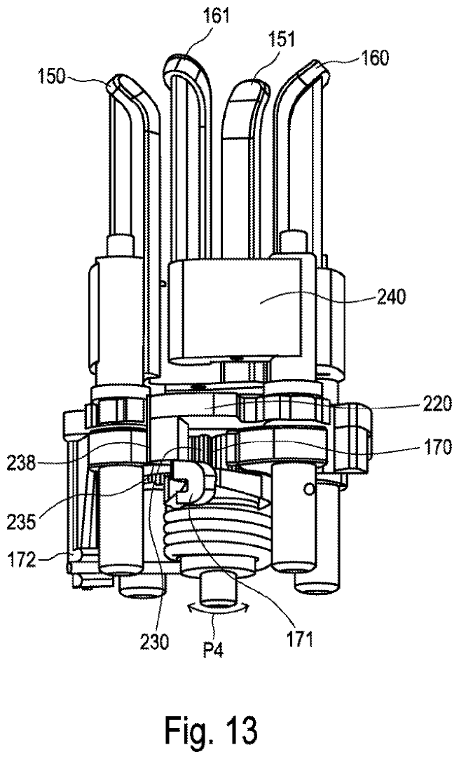

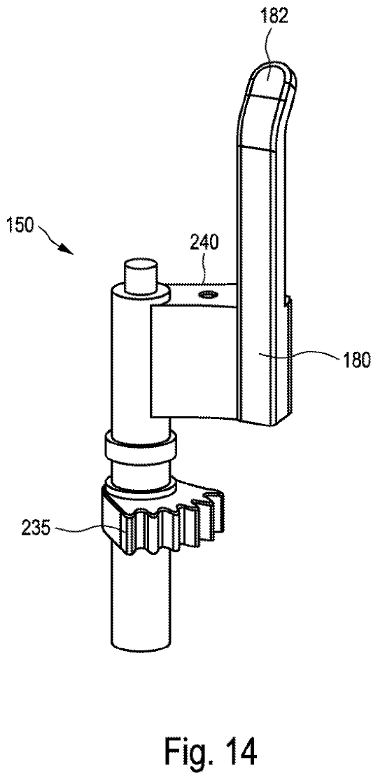

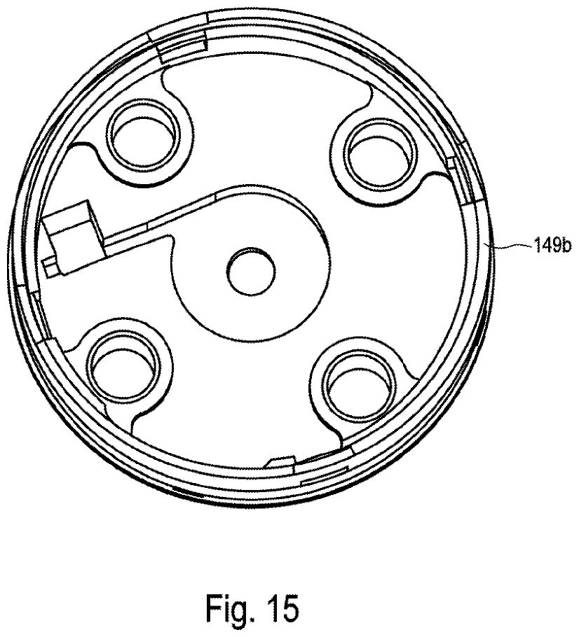

FIGS. 1-8 and 9-16 show an inventive sample container carrier 140 for holding a laboratory sample container 130 and for transporting the held laboratory sample container 130 in a laboratory sample distribution system 100. The sample container carrier can comprise a first holding element 150, a second holding element 160, a coupler 170 and a prevention element 220. The first holding element 150 and the second holding element 160 can be displaceable towards and/or away from each other within a holding region 165 for holding the laboratory sample container 130. The coupler 170 can be connected to the first holding element 150 and to the second holding element 160 within a coupling region 166 such that the coupler 170 can couple displacements of the first holding element 150 and the second holding element 160. The prevention element 220 can be arranged between the holding region 165 and the coupling region 166 and can be configured to prevent the laboratory sample container 130 and/or a laboratory sample 135 from getting into the coupling region 166.

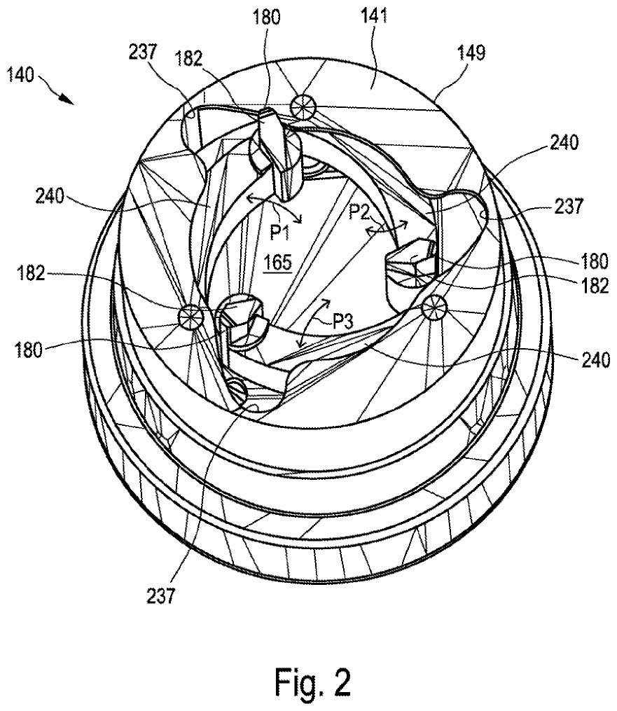

In the shown embodiment, the sample container carrier 140 can comprise a third holding element 151. In alternative embodiments, the sample container carrier may comprise only two holding elements such as, for example, the first holding element and the second holding element. Furthermore, in alternative embodiments, the sample container carrier may comprise four or more than four holding elements. All of the holding elements 150, 151, 160 can be rotationally displaceable towards and/or away from each other within the holding region 165 for holding the laboratory sample container 130, as shown in FIG. 2 by arrows P1, P2, P3. The coupler 170 can be connected to all of the holding elements 150, 151, 160 within the coupling region 166 such that the coupler 170 can couple displacements of all of the holding elements 150, 151, 160, in particular with each other.

The coupling region 166 can be defined by the prevention element 220 and a base body 149 of the sample container carrier 140. The coupler 170 can be arranged within the coupling region 166. Besides, the base body 149 of the sample container carrier 140 can be shaped such that a central axis CA can be a longitudinal axis of the base body 149.

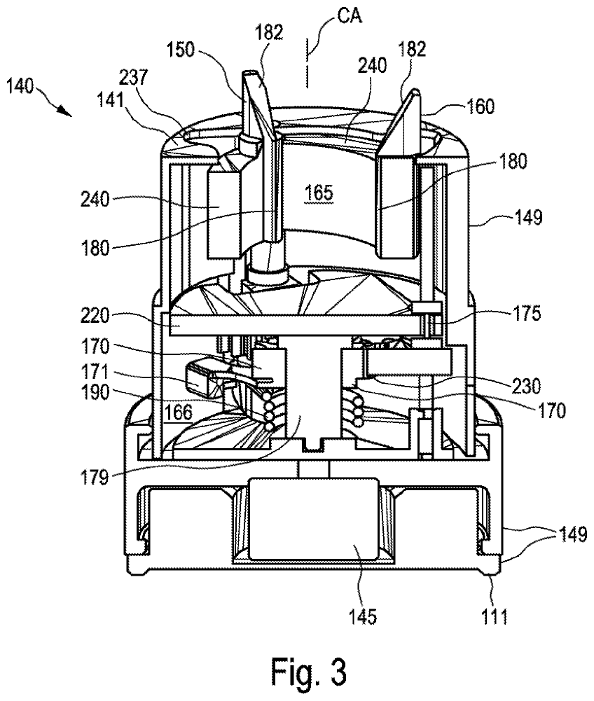

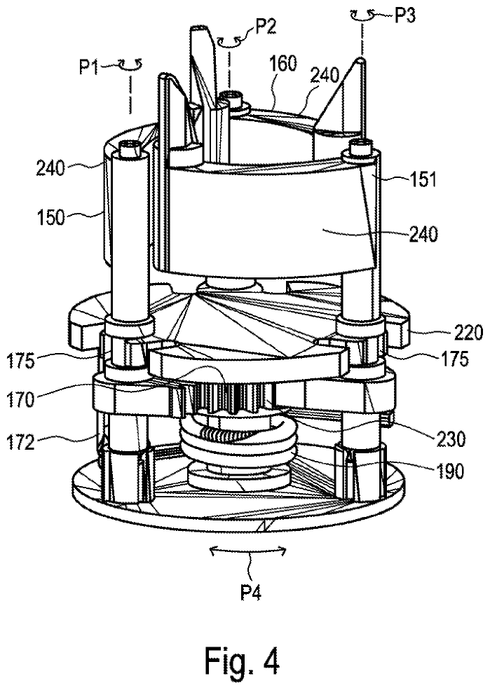

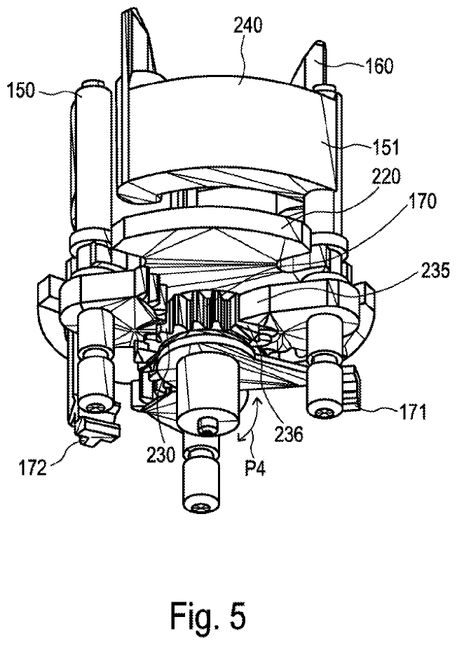

In detail, the coupler 170 can be rotationally moveable such that the coupler 170 can couple by its rotational movement the displacements of the holding elements 150, 151, 160. In the shown embodiment, the sample container carrier 140 can comprise a coupler-holder 179, as shown in FIG. 3. The coupler-holder 179 can extend from the prevention element 220 away into the coupling region 166 such as, for example, along the central axis CA and/or to the base body 149. In detail, the prevention element 220 and the coupler-holder 179 can be embodied as one piece. The coupler 170 can be moveably mounted such as, for example, pivot-mounted, to the coupler-holder 179 such that the central axis CA can be a rotational axis of the coupler 170, as shown in FIGS. 4 and 5 by an arrow P4.

In the shown embodiment, the sample container carrier 140 can comprise a gear tooth system 230. The coupler 170 can be connected to the holding elements 150, 151, 160 by the gear tooth system 230. The gear tooth system 230 can be arranged within the coupling region 166. In detail, the coupler 170 can comprise a form of a gear-wheel and the holding elements 150, 151, 160 can comprise a form of a segment of a gear-wheel. The gear-wheel shaped coupler 170 can mesh with the gear-wheel segments of the holding elements 150, 151, 160.

The holding elements 150, 151, 160 can be displaceable mounted to the prevention element 220 such as, for example, by a pivot joint 175, as shown in FIGS. 3 to 5. In detail, each holding element 150, 151, 160 can be mounted to the prevention element 220 by a latch type connection. Furthermore, the holding elements 150, 151, 160 can be displaceable mounted to the base body 149. Additionally, the prevention element 220 and the base body 149 can be configured to guide the displacements of the holding elements 150, 151, 160.

Moreover, the holding elements 150, 151, 160 can comprise a number of jaws 180 within the holding region 165 for holding the laboratory sample container 130. In the shown embodiment, each holding element 150, 151, 160 can comprise only one jaw 180. In alternative embodiments, at least one of the holding elements may comprise two, three or more than three jaws.

In detail, the jaws 180 can be distributed around the central axis CA in an equidistant and equiangular manner. In the shown embodiment, an angle between the three jaws 180 can be 120 degrees.

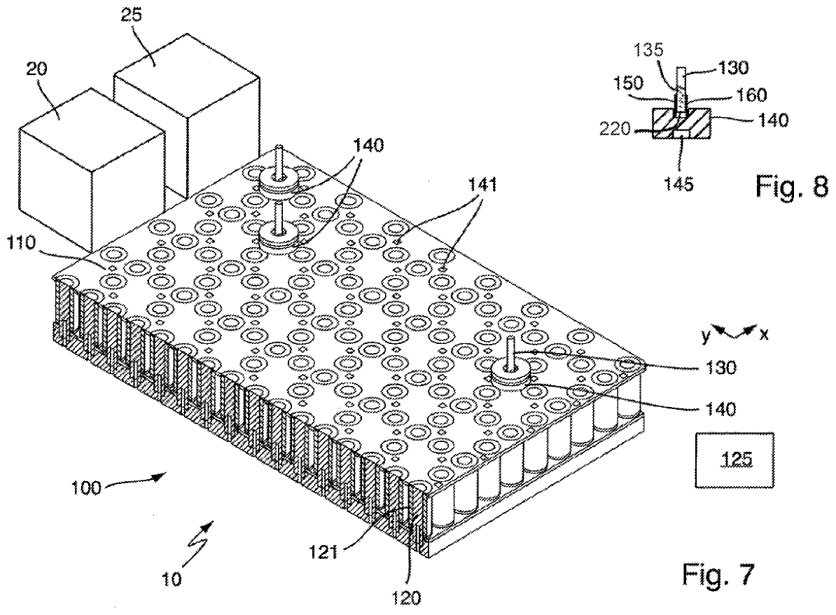

The jaws 180 can be configured to be in direct contact with the laboratory sample container 130 within the holding region 165, as shown in FIGS. 7 and 8. In one embodiment, the holding elements 150, 151, 160 and their jaws 180, respectively, can be arranged in a symmetric manner around the central axis CA of the sample container carrier 140 such that a point or line of contact of each of the holding elements 150, 151, 160 with the laboratory sample container 130 can be equidistant from the central axis CA. In detail, the number of jaws 180 can comprise a flexible and/or soft material for holding the laboratory sample container 130.

In the shown embodiment, the prevention element 220 is embodied as a plate. The prevention element 220 can be configured to prevent liquid and/or dust from getting into the coupling region 166. In detail, the prevention element 220 can directly contact the base body 149, as shown in FIG. 3. Furthermore, the prevention element 220 can be configured to support the laboratory sample container 130. In other words, the prevention element 220 can limit an insertion depth of the laboratory sample container 130.

The holding region 165 can be defined by the holding elements 150, 151, 160 and the prevention element 220. The prevention element 220 can separate the holding region 165 from the coupling region 166. The coupling region 166 and the holding region 165 can be arranged along the central axis CA. Furthermore, the holding region 165 can be surrounded and/or closed by the base body 149 with the exception, that the holding region 165 can be open at a top side 141 of the sample container carrier 140 for enabling an insertion of the laboratory sample container 130 into the sample container carrier 140.

In the shown embodiment, the laboratory sample container 130 can be designed as a tube having an opening at an in FIGS. 7 and 8 upper end. An end face of the laboratory sample container 130 can be supported by the prevention element 220. The jaws 180 can hold or clamp the laboratory sample container 130 at its circumference. The opening of the laboratory sample container 130 can be facing away from the sample container carrier 140 and its prevention element 220, respectively.

The holding elements 150, 151, 160 and their jaws 180, respectively, can be configured to hold the laboratory sample container 130 such that a longitudinal axis of the laboratory sample container 130 in form of the tube accords with the central axis CA.

Further, the holding elements 150, 151, 160 and their jaws 180, respectively, can extend from the prevention element 220 away into the holding region 165 by approximately 15 mm. In one embodiment, a vertical length of the holding elements 150, 151, 160 and their jaws 180, respectively, within the holding region 165 can be approximately 15 mm. In other words, the holding elements 150, 151, 160 can be configured to hold the laboratory sample container at an approximately 10 to 15 mm long end portion of the laboratory sample container 130. Thereby, a part of the circumference of the laboratory sample container 130 may not be covered by the holding elements 150, 151, 160 and their jaws 180, respectively. In other words, the part of the circumference can be visible from the outside. For example, the laboratory sample container 130 may comprise a not shown barcode at its circumference, which can be kept visible, when the laboratory sample container 130 can be held by the sample container carrier 140.

Furthermore, each of the holding elements 150, 151, 160 can comprise a lever arm 240. The lever arm 240 can comprise a curved shape. The respective jaw 180 can be arranged at an end portion of the lever arm 240 such that the lever arm 240 may not be in contact with the laboratory sample container 130 when the laboratory sample container 130 can be inserted into, held by, and/or removed from the sample container carrier 140.

Moreover, the holding elements 150, 151, 160 and their jaws 180, respectively, each can comprise an insertion support 182, as shown in FIG. 1. Each of the insertion supports 182 can be configured to cooperate together with the laboratory sample container 130 to be held such that the holding element 150, 151, 160 comprising the insertion support 182 can be displaced, when the laboratory sample container 130 is inserted into the sample container carrier 140. In the shown embodiment, each insertion support 182 can be embodied as an inclined plane. In detail, each insertion support 182 can be facing towards the central axis CA. An angle between the central axis CA and a respective insertion support 182 may be in the range of 5 degrees to 45 degrees.

Further, the sample container carrier 140 can comprise a retaining element 190 applying a force to the coupler 170 such that the holding elements 150, 151, 160 can be force-loaded towards each other for holding the laboratory sample container 130, as shown in FIGS. 3 and 4. In the shown embodiment, the retaining element 190 can be mounted to the coupler 170 and the prevention element 220. In detail, the coupler 170 can comprise a coupler protrusion 171 and the prevention element 220 can comprise a prevention protrusion 172, as shown in FIGS. 3 to 5. The retaining element 190 can be mounted to the coupler protrusion 171 and to the prevention protrusion 172. In alternative embodiments, additionally or alternatively, the retaining element may be mounted to at least one of the holding elements and/or to the base body. Moreover, in alternative embodiments, the retaining element may not have to be mounted to the coupler and/or to the prevention element. In the shown embodiment, the retaining element 190 can be an elastic element in the form of a spring such as, for example, in form of a leg spring. In detail, the retaining element 190 in the form of the spring can surround the coupler-holder 179.

Additionally, the retaining element 190 can apply a force such that the holding elements 150, 151, 160 can be displaced towards each other such as, for example, into a default position, when the laboratory sample container 130 is removed from the sample container carrier 140.

In the shown embodiment, the prevention element 220 such as, for example, in the form of the plate, the coupler 170 such as, for example, the gear tooth system 230, and the retaining element 190 such as, for example, in the form of the spring, can be arranged along the central axis CA, in particular in this order.

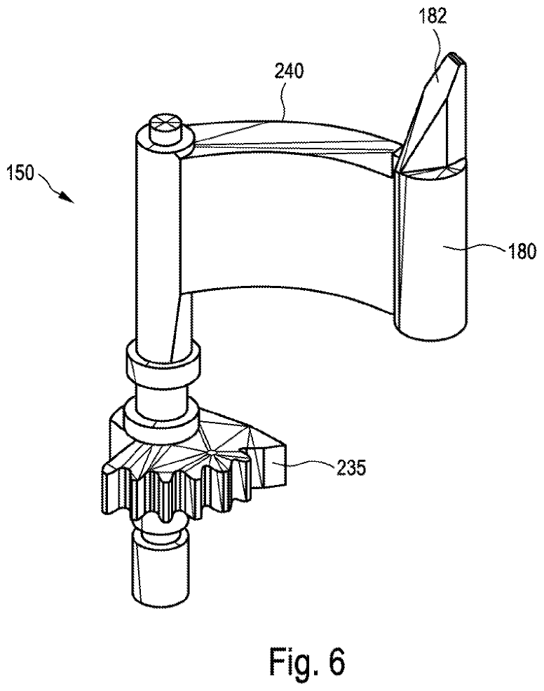

Furthermore, the sample container carrier 140 can comprise at least one stop element 235, as shown in FIGS. 5 and 6. The at least one stop element 235 can be configured to cooperate with the holding elements 150, 151, 160 and the coupler 170 such that the displacements of the holding elements 150, 151, 160, in particular towards each other, can be limited. In one embodiment, the at least one stop element 235 can define the default position.

In the shown embodiment, the respective stop element 235 can be fixed at a corresponding holding element 150, 151, 160. In one embodiment, the respective stop element 235 and the corresponding holding element 150, 151, 160 can be embodied as one piece. The respective stop element 235 can be arranged adjacent to the gear-wheel segment of the corresponding holding element 150, 151, 160. In the default position, the at least one stop element 235 can contact the coupler 170 at a corresponding stop surface 236 of the coupler 170, such that a further rotational movement of the coupler 170 can be blocked.

In the default position, a distance between the jaws 180 can be smaller than a minimal diameter of the laboratory sample container 130 to be held. However, a distance between the upper ends of the insertion supports 182 can be larger than a maximal diameter of the laboratory sample container 130 to be held.

Moreover, the base body 149 can comprise at least one displacement stop 237, as shown in FIG. 2. The at least one displacement stop 237 can be configured to limit the displacements of the holding elements 150, 151, 160 and their jaws 180, respectively, when the holding elements 150, 151, 160 are displaced away from each other such as, for example, by contact of the at least one displacement stop 237 with at least one of the holding elements 150, 151, 160.

In the shown embodiment, the at least one stop element 235 can be arranged within the coupling region 166. In alternative embodiments, the stop element may be arranged at a different position in or at the sample container carrier. In the shown embodiment, the at least one displacement stop 237 can be comprised by or arranged at the base body 149. In alternative embodiments, the displacement stop may be arranged at a different position in or at the sample container carrier.

When the laboratory sample container 130 can be inserted into the sample container carrier 140 towards the prevention element 220, the laboratory sample container 130 can contact at least one of the insertion supports 182 and can cooperate with it. Thereby, the corresponding holding element 150, 151, 160 and via the coupler 170 the other holding elements 150, 151, 160 can be displaced away from each other out of the default position, as shown in FIG. 1 by arrows P1, P2, P3.

When the laboratory sample container 130 is present within the holding region 165 between the holding elements 150, 151, 160 and their jaws 180, respectively, and supported by the prevention element 220, the retaining element 190 can push and/or pull the holding elements 150, 151, 160 against the laboratory sample container 130. The coupler 170 can ensure that the holding elements 150, 151, 160 can apply similar or identical holding force values to the laboratory sample container 130.

Moreover, the sample container carrier 140 can comprise a magnetically active element 145 in form of a permanent magnet, as shown in FIG. 3. The magnetically active element 145 can be configured to interact with a magnetic field generated by a drive element 120 such that a driving force can be applied to the sample container carrier 140. In detail, the magnetically active element 145 can be arranged within a cavity of the base body 149 such as, for example, in a lower part of the base body 149. Thereby, the magnetically active element 145 may not be translationally displaceable relative to the base body 149.

Further, the sample container carrier 140 can comprise a sliding surface 111 at its underside. In detail, the base body 149 such as, for example, its lower part, can comprise an annular-shaped sliding surface 111.

FIG. 7 shows an inventive laboratory automation system 10. The laboratory automation system 10 can comprise an inventive laboratory sample distribution system 100 and a number of laboratory stations 20, 25. The number of laboratory stations 20, 25 may comprise at least one pre-analytical, analytical and/or post-analytical station. In the shown embodiment, the laboratory stations 20, 25 can be arranged adjacent to the laboratory sample distribution system 100. Self-evidently, more than the two laboratory stations 20, 25 depicted in FIG. 7 may be comprised in the laboratory automation system 10.

The laboratory sample distribution system 100 can comprise a number of sample container carriers 140 as described above and/or below. Self-evidently, more than the three sample container carriers 140 depicted in FIG. 7 may be comprised in the laboratory sample distribution system 100. Furthermore, the laboratory sample distribution system 100 can comprise a transport plane 110, a number of drive elements 120 and a control device 125. The transport plane 110 can be configured to support the number of sample container carriers 140. The number of drive elements 120 can be configured to move the number of sample container carriers 140 on the transport plane 110. The control device 125 can be configured to control the number of drive elements 120 such that the number of sample container carriers 140 can move on the transport plane along corresponding transport paths, such as, for example, each of the sample container carriers 140 along an individual transport path simultaneously.

The laboratory sample distribution system 100 can be configured to distribute the number of sample container carriers 140 and/or the laboratory sample containers 130 between the laboratory stations 20, 25.

At least one of the laboratory stations 20, 25 may comprise or be a gripper station for inserting the laboratory sample container 130 to the sample container carrier 140 or for removing the laboratory sample container 130 from the sample container carrier 140.

In detail, the number of drive elements 120 can comprise a number of electro-magnetic actuators 121. The number of electro-magnetic actuators 121 can be stationary arranged below the transport plane 110 and can be configured to generate a magnetic field to move the number of sample container carriers 140 on the transport plane 110. In the shown embodiment, the electro-magnetic actuators 121 can be implemented as solenoids having a solid ferromagnetic core. The electro-magnetic actuators 121 can be quadratically arranged in a grid having rows and columns such as, for example, in a plane parallel to the transport plane 110. In each center of a quadrat formed by corresponding electro-magnetic actuators 121, no electro-magnetic actuator may be arranged. In other words, in each second row in each second position, there is no electro-magnetic actuator 120.

The magnetically active element 145 of a respective sample container carrier 140 can be configured to interact with the magnetic field generated by the number of electro-magnetic actuators 121 such that a magnetic driving force can be applied to the sample container carrier 140.

The control device 125 can be configured to control the number of electro-magnetic actuators 121 such that the number of sample container carriers 140 can move on the transport plane along corresponding transport paths.

In detail, the electro-magnetic actuators 121 can be driven individually such as, for example, by the control device 125, in order to generate a magnetic field for each sample container carrier 140. The magnetic field can interact with the magnetically active device 145 of the sample container carriers 140. As a result of the interaction, the magnetic driving force can be applied to the sample container carrier 140. Hence, the sample container carriers 140 can be translationally moved in two dimensions x, y being substantially perpendicular to each other on or over the transport plane 110. In the shown embodiment, the sliding surface 111 of a respective sample container carrier 140 can be configured to be in contact with the transport plane 110 and can enable performing movements such as, for example, slides, of the sample container carrier 140 on the transport plane 110.

Furthermore, the laboratory sample distribution system 100 can comprise a number of Hall-sensors 141. The number of Hall-sensors 141 can be arranged such that a position of a respective sample container carrier 140 on the transport plane 110 can be detected. The control device 125 can be functionally coupled to the Hall-sensors 141 for detecting the position of the sample container carrier 140. The control device 125 can be configured to control the electro-magnetic actuators 121 in response to the detected position.

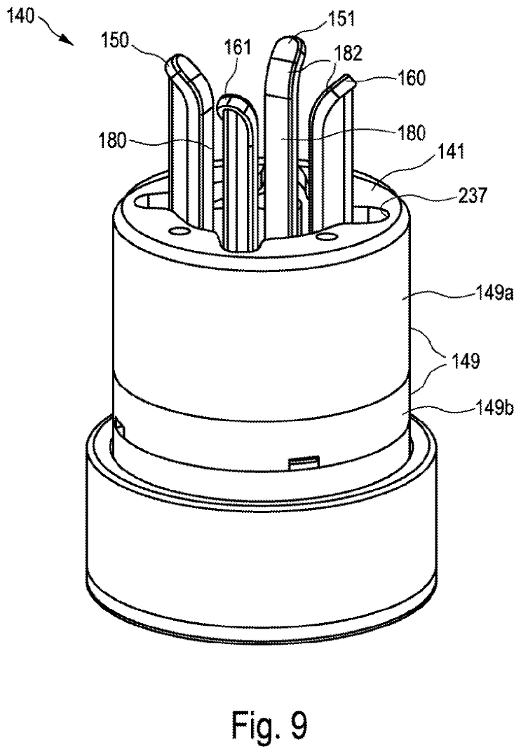

In the embodiment shown in FIGS. 9 to 16, the sample container carrier 140 can comprise a third holding element 151 and a fourth holding element 161. In alternative embodiments, the sample container carrier may comprise only two holding elements such as, for example, the first holding element and the second holding element. Furthermore, in alternative embodiments, the sample container carrier may comprise three or more than four holding elements.

Furthermore, in the embodiment shown in FIGS. 9 to 16, an angle between the four jaws 180 can be approximately 90 degrees.

Moreover, in the embodiment shown in FIGS. 9 to 16, the holding elements 150, 151, 160, 161 and their jaws 180, respectively, can extend from the prevention element 220 away into the holding region 165 by about 30 mm. In one embodiment, a vertical length of the holding elements 150, 151, 160, 161 and their jaws 180, respectively, within the holding region 165 can be about 30 mm.

Further, in the embodiment shown in FIGS. 9 to 16, the at least one stop element 235 can be configured to cooperate with the holding elements 150, 151, 160, 161 such that the displacements of the holding elements 150, 151, 160, 161 may be limited.

In the embodiment shown in FIGS. 9 to 16, the respective stop element 235 can be a part of the gear-wheel segment of the corresponding holding element 150, 151, 160, 161. In the default position, the at least one stop element 235 can contact the prevention element 220 at a corresponding stop surface 238 of the prevention element 220 such that a further rotational movement of the respective holding element 150, 151, 160, 161 can be blocked.

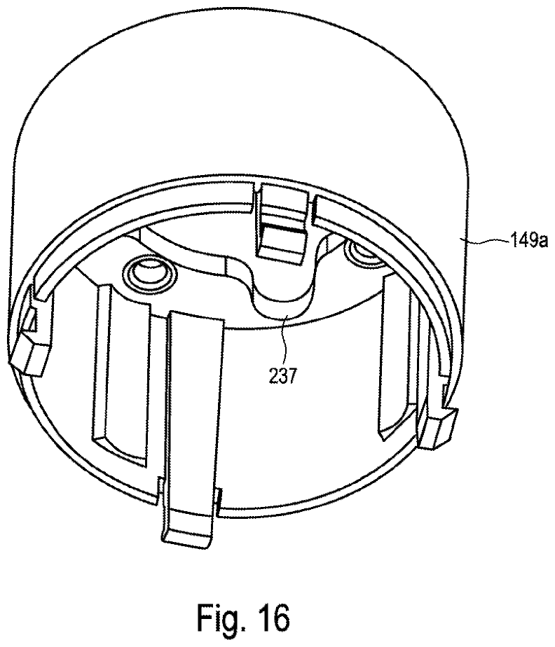

Furthermore, in the embodiment shown in FIGS. 9 to 16, an upper part or a housing, respectively, of the base body 149 can comprise two, in particular different, housing parts 149a, 149 b, as shown in FIGS. 15 and 16.

In detail, one of the housing parts can be an upper housing part 149a and another one of the housing parts is a lower housing part 149b such as, for example, arranged along the central axis CA.

This, in one embodiment, the two-piece housing, can enable an easy assembly of the sample container carrier 140 such as, for example, of the holding elements 150, 151, 160, 161, the coupler 170 and the prevention element 220.

In the embodiment shown in FIGS. 9 to 16, the upper housing part 149a and the lower housing part 149b can be connected such as, for example, mechanically connected, to each other by a snap type connection. In alternative embodiments, the upper housing part and the lower housing part may be connected to each other by a different type of connection.

Moreover, the sample container carrier 140 such as, for example, its base body 149, may comprise at least one element such as, for example, at its underside, to retain the magnetically

It is noted that terms like “preferably,” “commonly,” and “typically” are not utilized herein to limit the scope of the claimed embodiments or to imply that certain features are critical, essential, or even important to the structure or function of the claimed embodiments. Rather, these terms are merely intended to highlight alternative or additional features that may or may not be utilized in a particular embodiment of the present disclosure.

For the purposes of describing and defining the present disclosure, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the present disclosure in detail and by reference to specific embodiments thereof, it will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these preferred aspects of the disclosure.

We claim:

1. A sample container carrier for holding a laboratory sample container and for transporting the held laboratory sample container in a laboratory sample distribution system, the sample container carrier comprising:
a first holding element;
a second holding element, wherein the first holding element and the second holding element are displaceable towards and/or away from each other within a holding region for holding the laboratory sample container and wherein at least one of the first and second holding elements is rotationally displaceable;
a coupler, wherein the coupler is connected to the first holding element and to the second holding element within a coupling region such that the coupler couples displacements of the first holding element and the second holding element and wherein the coupler is rotationally moveable such that the coupler couples by its rotational movement the displacements of the first holding element and the second holding element;
a prevention element, wherein the prevention element is spatially arranged between the holding region and the coupling region and is configured to prevent the laboratory sample container and/or a laboratory sample from getting into the coupling region, wherein the coupling region and the holding region are arranged along a central axis (CA) of the sample container carrier, and wherein the coupler is moveably mounted to the prevention element; and
a coupler-holder, wherein the coupler-holder extends from the prevention element away into the coupling region, wherein the prevention element and the coupler-holder are embodied as one piece, and wherein the coupler is pivot-mounted to the coupler-holder such that the central axis (CA) is a rotational axis of the coupler.

2. The sample container carrier according to claim 1, further comprising,
a gear tooth system, wherein the coupler is connected to the first holding element and/or to the second holding element by the gear tooth system.

3. The sample container carrier according to claim 1, further comprising,
a stop element, wherein the stop element is configured to cooperate with the first holding element and/or the second holding element and/or the coupler such that the displacements of the first holding element and the second holding element are limited.

4. The sample container carrier according to claim 1, wherein the first holding element and/or the second holding element are mounted to the prevention element.

5. The sample container carrier according to claim 1, wherein the first holding element and/or the second holding element extend/s from the prevention element away into the holding region by maximum of 35 mm.

6. The sample container carrier according to claim 1, wherein the first holding element and/or the second holding element extend/s from the prevention element away into the holding region by maximum of 30 mm.

7. The sample container carrier according to claim 1, wherein the first holding element and/or the second holding element extend/s from the prevention element away into the holding region by maximum of 25 mm.

8. The sample container carrier according to claim 1, wherein the first holding element and/or the second holding element extend/s from the prevention element away into the holding region by maximum of 15 mm.

9. The sample container carrier according to claim 1, wherein the first holding element and/or the second holding element comprise/s a number of jaws within the holding region for holding the laboratory sample container.

10. The sample container carrier according to claim 9, wherein the first holding element and/or the second holding element comprise/s a lever arm, wherein the lever arm comprises a curved shape and wherein the jaw is arranged at the lever arm such that the lever arm is not in contact with the laboratory sample container when the laboratory sample container is inserted into, held by and/or removed from the sample container carrier.

11. The sample container carrier according to claim 9, wherein the number of jaws comprises a flexible and/or soft material for holding the laboratory sample container.

12. The sample container carrier according to claim 1, wherein the first holding element and/or the second holding element comprise/s an insertion support, wherein the insertion support is configured to cooperate together with the laboratory sample container to be held such that the holding element comprising the insertion support is displaced when the laboratory sample container is inserted into the sample container carrier.

13. The sample container carrier according to claim 1, further comprising,
a retaining element applying a force to the first holding element and/or to the second holding element and/or to the coupler such that the first holding element and the second holding element are force-loaded towards each other for holding the laboratory sample container.

14. The sample container carrier according to claim 1, further comprising,
a magnetically active element, wherein the magnetically active element is configured to interact with a magnetic field generated by a drive element such that a driving force is applied to the sample container carrier.

15. A laboratory sample distribution system, the laboratory sample distribution system comprising:
a number of sample container carriers according to claim 1;
a transport plane, wherein the transport plane is configured to support the number of sample container carriers;
a number of drive elements, wherein the number of drive elements is configured to move the number of sample container carriers on the transport plane; and
a control device, wherein the control device is configured to control the number of drive elements such that the number of sample container carriers moves on the transport plane along corresponding transport paths.

16. The laboratory sample distribution system according to claim 15, wherein the number of drive elements comprises a number of electro-magnetic actuators, wherein the number of electro-magnetic actuators is stationary arranged below the transport plane and is configured to generate a magnetic field to move the number of sample container carriers on the transport plane, wherein each of the number of sample container carriers comprises a magnetically active element, wherein the magnetically active element is configured to interact with the magnetic field generated by the number of electro-magnetic actuators such that a driving force is applied to the sample container carrier, and wherein the control device is configured to control the number of electro-magnetic actuators such that the number of sample container carriers moves on the transport plane along corresponding transport paths.

17. A laboratory automation system, the laboratory automation system comprising:
a number of laboratory stations; and
a laboratory sample distribution system according to claim 15, wherein the laboratory sample distribution system is configured to distribute the number of sample container carriers and/or laboratory sample containers between the laboratory stations.
